(19) United States
(12) Patent Application Publication
(10) Pub. No.: US 2012/0060034 A1
(43) Pub. Date: Mar. 8, 2012

(54) DIGITAL INFORMATION STREAM COMMUNICATION SYSTEM AND METHOD

(75) Inventors: George T. Hutchings, Doylestown, PA (US); Lawrence D. Vince, Lansdale, PA (US)

(73) Assignee: GENERAL INSTRUMENT CORPORATION, Horsham, PA (US)

(21) Appl. No.: 12/874,850

(22) Filed: Sep. 2, 2010

(51) Int. Cl. G06F 15/16; H04L 9/32

(52) U.S. Cl. 713/171; 709/231

(57) ABSTRACT

A digital information stream communication (DISC) system within a first conditional access system (CAS) is disclosed. The DISC system communicates information from a digital information stream (DIS) having DIS attributes for accessibility using the first CAS or associated with a digital media (DM) content in the DIS. The DISC system includes a monitoring module configured to receive the DIS and identify one or more of the DIS attributes for accessibility using the first CAS. The DISC system also includes a processing module configured to identify one or more of the DIS attributes associated with the DM content and analyze the DIS attributes. It does this to determine whether to send DIS data from the DIS to a second CAS based upon the DIS data being included in the DIS attributes. The DISC system also includes a processor configured to operate the monitoring module and the processing module.

### BACKGROUND

Digital media (DM) content is often encrypted to prevent unauthorized use. Furthermore, access to encrypted DM content may be secured through content protection technologies such as a conditional access system (CAS) or a digital rights management system (DRMS). A CAS may generally determine whether any access is granted to DM content. A DRMS may generally restrict the use of secured DM content by controlling the levels of access, copying or conversion to other formats by end users. A client device, such as a consumer electronic device, may be granted access to and be capable of rendering, or otherwise using, DM content. This access can be based on the rights granted to the client device by a DRMS associated with the DM content and/or a CAS.

For example, in a video-on-demand (VOD) platform (e.g., including a headend facility and associated client devices at customer premises), a CAS for DM content distributed through a VOD platform may reside, in part, in both a headend facility and, in part, on the subscriber client devices associated with the VOD platform. The CAS for a VOD platform usually includes software and/or hardware for the implementation of different functions. One such function is signal scrambling/descrambling, wherein a signal is scrambled at a headend facility and descrambled at the client device. Another function is processing, such as encryption or decryption, of any electronic keys needed by a subscriber. An electronic key, in this context, is a password, phrase or some other code usable to unlock an encryption algorithm associated with the DM content distributed through the VOD platform. A third function is operation of a subscriber management system which ensures that those subscribers who are entitled to watch select scrambled programs distributed through the VOD platform are able to access the programs through their client device, which may include a set-top box. A client device may operate with one or more CASs. A client device may also interact with a DRMS to ensure the user has rights and is able to access various types of DM content.

In many situations, more than one CAS may be utilized to distribute DM content to subscribers. For instance, a VOD platform may utilize different CASs based on the manner of its distribution. This might occur when one CAS is used for cable distribution and a second CAS is used for satellite distribution of the same movie or program. Another example is if different CASs are necessary based on the dispersed geographical location of different client devices receiving the DM content. Yet another example is when the DM content is distributed to different types of client devices providing different types of services.

In some situations, the DM content provider may change accessibility criteria for accessing the DM content which is controlled through multiple CASs, but the DM content provider only provides the changed accessibility criteria to one or some of the multiple CASs associated with the DM content. For example, the accessibility criteria for the DM content may be altered due to a change in the format associated with the DM content, such as might occur when a digital video stream changes from 2D to 3D for a given television program and the 3D format requires a different level of authorization. The information stream includes attributes relating to the changes in accessibility associated with the level of authorization needed to view the 3D content. In this situation, a CAS associated with a client device may not be able to determine the changed accessibility because the DM content provider did not provide the changed accessibility as attributes in the information stream that is readable by the CAS for the client device. As a result, the subscriber using this client device and CAS cannot access the 3D version of the program.

Furthermore, multiple CASs typically cannot share information derived from a program stream in real-time. If one CAS was able to determine access criteria for a program from a program stream, there is no mechanism to share this information with a second CAS in real-time that does not have access to the program stream. Accordingly, the client devices using the second CAS may not get access to the program or other services for lack of knowledge of the changed access criteria.

### BRIEF SUMMARY OF THE INVENTION

The disclosure, according to an embodiment, presents a system to communicate information from a digital information stream (DIS). The digital information stream communication (DISC) system can enable access to DM content and optimize the interoperability between different CASs, different client devices and different headend facilities. The DISC system provides information in real-time, taken from a DIS, to various client devices and headend facilities by using the accessibility to the DIS information available through a first CAS. The DISC system then sends select DIS information to a second CAS. The second CAS may operate in a client device or a headend facility which does not use the first CAS. The DISC system therefore allows these client devices and headend facilities to obtain access to information from sources which may not otherwise be possible in certain situations. Accordingly, the DISC system enhances services, such as VOD services for secured DM content, from the service user's perspective. This is useful, for instance, in a VOD or similar platform deploying secured DM content through a DIS which has changing access criteria for different types of client devices and/or changing information in DIS packets regarding the secured DM content contained in a DIS packet payload. By providing client devices and headend facilities access through the DISC system to otherwise unavailable or secured information contained in the DIS, the DISC system facilitates this DIS information being utilized by the client devices and headend facilities to optimize their operability.

The complete and total information in a DIS make up all the DIS attributes in the DIS. If any DIS attributes are identified and selected through the DISC system to be sent to a second CAS, this information is identified as DIS data. DIS attributes may include information for accessibility using the first CAS or information associated with DM content in the DIS. DIS attributes may also include other information in a DIS.

According to one embodiment, the disclosure presents a DISC system, within a first CAS. The DISC system is configured to communicate information from a DIS. The DISC system includes a monitoring module configured to receive the DIS and identify one or more of the DIS attributes for accessibility using the first CAS. The DISC system also includes a processing module configured to identify one or more of the DIS attributes associated with the DM content. The processing module analyzes the DIS attributes to determine whether to send any select DIS data from the DIS attributes to a second CAS based upon the DIS data being included in the DIS attributes and meeting criteria for sending as DIS data. If the DIS data is not included in the DIS attributes, the DISC system does not send any DIS data to the second CAS. The DISC system also includes a processor configured to operate the monitoring module and the processing module.

According to another embodiment, the disclosure presents a method of communicating information from a DIS having DIS attributes for accessibility using a first CAS or associated with DM content in the DIS. The method includes receiving the DIS at a first CAS, identifying one or more of the DIS attributes for accessibility using the first CAS, and identifying one or more of the DIS attributes associated with the DM content. The method also includes analyzing the DIS attributes to determine whether to send DIS data from the DIS to a second CAS based upon the DIS data being included in the DIS attributes. If the DIS data is not included in the DIS attributes, the DISC system does not send the DIS data to the second CAS.

According to another embodiment, the disclosure presents a non-transitory computer readable medium storing computer readable instructions that when executed by a computer system perform a method of communicating information from a DIS having DIS attributes for accessibility using a first CAS or associated with DM content in the DIS. The method includes receiving the DIS at a first CAS, identifying one or more of the DIS attributes for accessibility using the first CAS, and identifying one or more of the DIS attributes associated with the DM content. The method also includes analyzing the DIS attributes to determine whether to send DIS data from the DIS to a second CAS based upon the DIS data being included in the DIS attributes. If the DIS data is not included in the DIS attributes, the DISC system does not send the DIS data to the second CAS.

### BRIEF DESCRIPTION OF DRAWINGS

Embodiments are described in detail in the following description with reference to the following figures.

FIG. 1 illustrates a system diagram of a DISC system, according to an embodiment;

FIG. 2 illustrates a system diagram of a DM content distribution platform including a DISC system shown in FIG. 1, according to an embodiment;

FIG. 3 illustrates a method of communicating information from a DIS using the DISC system shown in FIG. 1, according to an embodiment; and

FIG. 4 illustrates a computer system configured to provide a hardware platform for the DISC system shown in FIG. 1, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent however, to one of ordinary skill in the art, that the embodiments may be practiced without limitation to these specific details. In some instances, well known methods and structures have not been described in detail so as not to unnecessarily obscure the embodiments. Furthermore, different embodiments are described below. The embodiments may be used or performed together in different combinations.

### 1. Overview

DM content, such as VOD content, is often communicated to client devices from a server at a headend facility via a DIS. A DIS is any type of information stream including DM content, such as a transport stream (TS) or a packetized elementary stream, both being described in more detail below. The information carried in a DIS includes DIS attributes, such as DIS attributes for accessibility using a CAS or DIS attributes associated with a DM content in the DIS. DIS attributes may include DIS data. The complete and total information in a DIS make up all the DIS attributes in the DIS. If any DIS attributes are identified and selected through the DISC system to be sent to a second CAS, this information is identified as DIS data. DIS attributes may include information for accessibility using the first CAS or information associated with DM content in the DIS. DIS attributes may also include other information in a DIS. DIS data is information communicated from a DIS.

A DIS commonly includes data packets with the data packets having a packet payload and packet header. A DIS may also include messages or other conveyances for DIS attributes. For instance, encrypted DM content in a TS typically includes video, audio, and other associated TS data. This TS data is commonly formatted for storage and transmission into a video or audio elementary data according to some standard, such as the MPEG-2 Systems Standard. The video and the audio elementary data are packetized into a video packetized elementary stream (video PES) packets and one or more audio packetized elementary stream (audio PES) packets. The video PES packets, audio PES packets, and associated data are, in turn, encapsulated into TS packets and multiplexed into a TS, which may be delivered to a receiving client device, such as a television set or a set top box (STB), via cable, satellite, or some other broadcast technology. A client device is any device that accesses DM content, and may include a set-top box, TV, or other end user devices.

Any client device is, in general, limited to accessing the DIS attributes for which the client device is authorized through a CAS associated with the client device. Client devices are provided access to secured DM content in a DIS through their associated CAS according to accessibility granted for the CAS to the secured DM content in the DIS. DIS attributes may be provided in packet payloads, headers, messages or other areas of the DIS.

A CAS network is a communications system or network through which authorization and de-authorization messages are sent, such as for authorizing whether a CAS has access to secured DM content in a DIS. The DIS attributes may include new access criteria for accessing the secured DM content. To obtain access to this other information for the client device, access must be obtained from another source than the DIS itself. Other sources for granting this access might be the content providers themselves or the system management of a headend facility. Obtaining access from other sources may not be possible in certain situations, and in those situations secured DM content may not be accessed. Essentially, this may be considered a disruption in service from the user's perspective and ultimately may result in a service provider losing customers.

According to an embodiment, a DIS communication (DISC) system is disclosed for accessing DIS attributes in a DIS using a first CAS and sending DIS data from a DIS to a second CAS. For instance, DIS attributes including accessibility for DM content may be readable from a DIS using a first CAS, but not a second CAS. The DISC system provides the advantage of sharing these DIS attributes as DIS data directly with a second CAS in real-time so client devices operating with the second CAS can use the DIS data to access the DM content.

The DIS attributes may include the access criteria and other information. DIS attributes include any attribute of DM content describing information for accessing or protecting DM content. In one example, the DIS attributes include previously established accessibility criteria or modified accessibility criteria for accessing DM content. For example, the DM content is a program. The content provider makes newly available Spanish audio for the program which is provided in the DIS with the program. DIS attributes are provided in the DIS describing accessibility criteria for accessing the Spanish audio. The DISC system is operable to identify the DIS attributes from the DIS and provide them to a second CAS in real-time as DIS data so client devices using the second CAS can access the Spanish audio.

A DIS, such as an MPEG-2 standard TS, may carry several programs, each of which is made up of one or more program elements which make up the DM content in the TS. The DIS attributes in a TS is often divided among TS packets. In general, an MPEG-2 TS packet includes a payload of DM content DIS attributes about the DM content, and DIS attributes associated with accessibility criteria for obtaining access to the DM content. The accessibility criteria can include data relating to a DRMS associated with the DM content carried in the TS packet payload. The TS packet payload, header or an attached message, may also contain information about the DIS attributes for the DM content in the payload area. The DM content DIS attributes can be any information describing the DM content. This includes, for example, information describing the size of the DM content data file or about the format of the DM content in the TS packet payload, such as formats for video, audio, text or some other format. As an example of a TS packet structure, in the MPEG-2 standard, each TS packet may be a 188-byte structure made up of a four-byte header and a payload of up to 184 bytes.

In the MPEG-2 standard, the DIS attributes in a TS packet can include a thirteen-bit packet identifier (PID) which is a unique integer value associated with a packet stream in a program. The relationships between the various video and audio elementary streams are defined by descriptive information called program specific information (PSI) included in the TS. PSI tables may contain information needed by receiving client devices to demultiplex and present programs. The PSI can include a program association table (PAT), a program map table (PMT), and/or a conditional access table (CAT) and a transport stream description table (TSDT). The PAT can provide the association between a program number and the packet identifier (PID) value of the TS packets carrying a program map table for that program. The PMT can provide the mappings between program numbers and the program stream elements that make up a program. The PMT may list the elementary stream components, the stream type of each component (e.g., audio stream, video stream, data stream, etc.), and the PID value associated with each elementary stream. The TSDT is another table which may be used to deliver information that is relevant to all programs within the TS multiplex. All these table types may be DIS attributes present in a DIS or DIS data communicated to a second CAS using a DISC to communicate the DIS data.

The CAT is a data table which may be used to identify TS packets carrying system-wide entitlement management messages (EMMs) and other private control messages through a digital TV network. An EMM is an encrypted message that is used to provide secure delivery of access rights to prevent unauthorized reception for such services as cable or satellite television. EMMs are often used in the management of conditional access to programming in a digital television system. An ECM is an entitlement control message which contains access criteria and a scrambled key called a control word. A series of ECMs is often included with the program stream and sent encrypted to the receiver, or STB, in an end user's location. If the user is authorized to acquire the reception, a subsystem in the receiver decrypts the message. The receiver can determine whether the user is authorized because the authority is sent to the receiver in an EMM. All these message types may be DIS attributes present in a DIS or DIS data communicated to a second CAS using a DISC to communicate the DIS data.

Scrambling and encryption are often used in a CAS to prevent users from gaining unauthorized access to DM content. A CAS can utilize a layered approach to security. For instance, every few seconds the control word can be changed and/or the ECMs also changed at longer intervals, such as every month, to prevent unauthorized users from gaining access. Protocols have been developed and are used in headend systems to enable the simultaneous use of multiple DRM systems for a given DM content. As an example, in the SimulCrypt protocol, a standardized SimulCrypt synchronizer (SCS) is utilized with an entitlement control message generator (ECMG) interface to allow multiple encryption key systems to operate in parallel, each generating its own ECMs. The DISC system disclosed below is operable through CAS networks associated with protocols, such as SimulCrypt, or other protocols involving multiple CAS systems, for accessing DIS attributes in a DIS, such as a TS, using a first CAS and for sending DIS data to a second CAS.

### 2. System

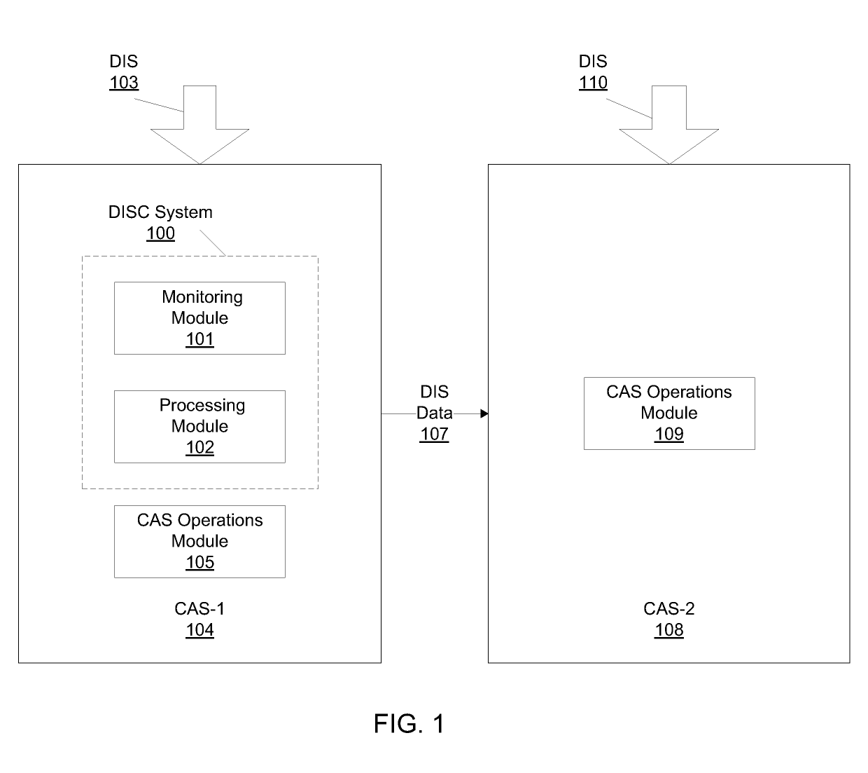

FIG. 1 illustrates a DISC system 100, according to an embodiment, within a first CAS, CAS-1 104. The DISC system 100 may include a monitoring module 101 and a processing module 102. The CAS-1 104 may also include a CAS operations module 105. The CAS operations module 105 is often located in a headend facility, but may be located outside a headend facility. The DISC system 100 may be operated with a processor as described in more detail below. The DIS 103 which is received at CAS-1 104 may originate from an external or upstream source. DISC 100 receives the DIS 103 at the monitoring module 101 where the monitoring module 101 identifies DIS attributes in the DIS 103 to determine whether the DM content in the DIS 103 is accessible, or can be made accessible, using CAS-1 104. The monitoring module 101 then passes the DIS 103 to the processing module 102. The processing module identifies DIS attributes associated with the DM content, in the DIS 103. Then the processing module 102 analyzes the DIS attributes to determine whether to any are to be tagged as DIS data 107 to be sent to a second CAS, such as CAS-2 108. The CAS-2 108 includes a CAS operations module 109 which may reside in the same headend facility as the CAS operations module 105 for the CAS-1 104. The CAS operations module 109 may reside in another headend facility or other location. The CAS-2 108 may receive a DIS 110 which may be the same as DIS 103, related to DIS 103 or be a completely distinct DIS from DIS 103.

The processing module 102 in the DISC system 100 is configured to evaluate the DIS attributes present in the DIS 103, and take action or not based on configured predetermined criteria for selecting DIS data 107. The predetermined criteria can be pre-set at the DISC system 100, or communicated to the DISC system 100 through a CAS network and/or from other sources. If the identified DIS attributes include the predetermined criteria (e.g., accessibility criteria for DM content), then these DIS attributes are tagged as DIS data 107 which is forwarded to CAS-2 108 and then through a delivery network to a decryption subsystem which decrypts the forwarded DIS data 107 into data that is usable by device operable with the CAS-2 108. In another embodiment, after the CAS-2 108 receives the DIS data 107, the CAS operations module 109 in CAS-2 108 processes the DIS data 107 into a data format that is proprietary to CAS-2 108. The data in the CAS-2 proprietary format can be delivered to devices directly from

CAS-2 108 or returned to CAS-1 104 for merging with the data delivered to various devices from CAS-1 104.

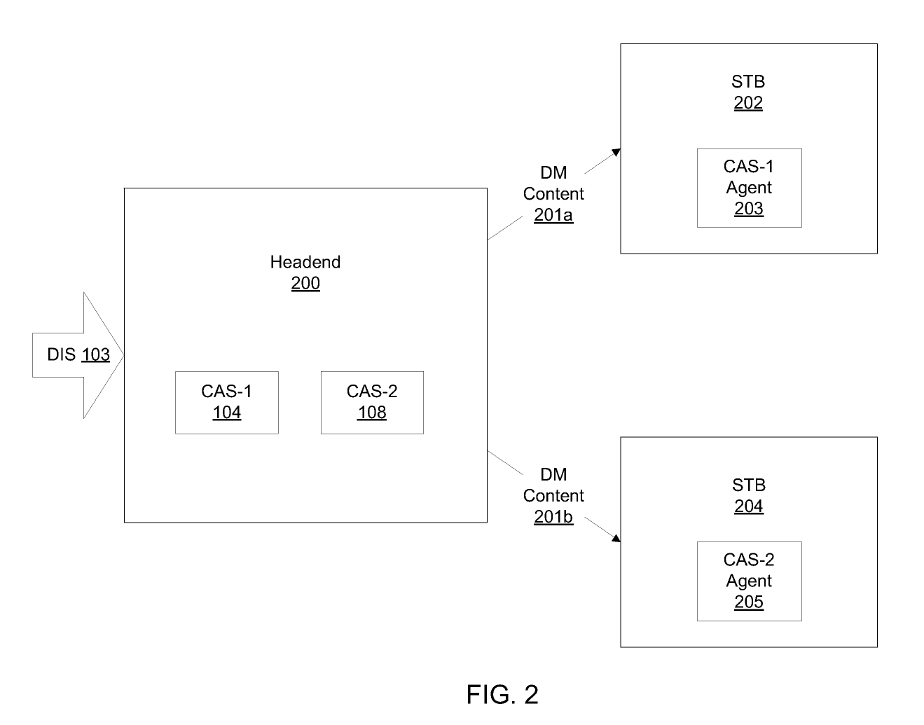

FIG. 2 illustrates distribution of a DM content 201a and a DM content 201 b from a headend 200 to, respectively, an STB 202 containing a CAS-1 agent 203 and an STB 204 containing a CAS-2 agent 205. The DIS 103 is received at headend 200 DIS 103 and contains DIS attributes that are readable by CAS-1 104, but not readable by CAS-2 108. DM content 201a is not affected by the DISC system 100 because all the DIS attributes in DIS 103 are readable and usable through CAS-1 104. However, the DISC system 100 extracts DIS data 107 and sends it to CAS-2 108, thus enhancing the operations at STB 204 using CAS-2 agent 205. This is because the DM content 201b contains all the DIS data 107 provided to CAS-2 108 through using the DISC system 100.

The DIS data 107 is forwarded to CAS-2 108, which may process it through the CAS operations module 109 and send it through a delivery network to a CAS-2 decryption subsystem (not shown) so that the DIS data 107 data may be utilized by a client device or headend system (not shown). The CAS operations modules 105 and 109 are used by their respective CAS to determine access criteria for accessing DM content in the DIS 103 and providing access to client devices based on the access criteria. The client devices may include CAS agents 203 and 205, shown in FIG. 2, working with a CAS operations module to determine and provide access to DM content in the DIS 103.

### 3. Example

An example is described with respect to the DISC system 100 shown in FIG. 1. The DIS 103 contains TS packets according to the MPEG-2 standard. A TS packet in DIS 103 includes a packet containing DIS attributes relating to DM content or DRMS accessibility describing program access rights. This information, in one instance, is in an MPEG table syntactic structure. DRMS accessibility data associated with the DM content are directly accessible in the packet via a first CAS, such as CAS-1 104, but not directly accessible using a second CAS, such as CAS-2 108.

The TS packet is received in the monitoring module 101 at the DISC system 100. The monitoring module 101 forwards the TS packet to the processing module 102. The first CAS, CAS-1 104, and the second CAS, CAS-2 108, both communicate through a CAS network. The processing module 102 analyzes the incoming TS packets. The DISC system 100 is used to identify DRMS information and the copy control information associated with DM content present in the DIS 103. CAS-1 104 forwards the DRMS information and the copy control information as DIS data 107 to CAS-2 108. CAS-2 108 prepares the DM content, DRMS data, and or the copy control information in its respective proprietary format, and then forwards the DIS data 107 to an the output subsystem in CAS-2 108 for multiplexing with existing information as provided. The output data stream is then forwarded through a CAS delivery network to a CAS-2 client decryption subsystem forming data which is a decrypted data stream accessible by a client device such as an STB associated with the CAS-2. In another embodiment, the output data stream or the decrypted data stream may be delivered via CAS-1 104, for example using the CAS operations module 105. In this embodiment, the CAS operations module 109 on CAS-2 108 does not have direct access to DIS data 107.

In the example, the second CAS, CAS-2 108, has communicated predetermined criteria to the DISC system 100 in the first CAS, CAS-1 104, requesting the forwarding of information to the second CAS, CAS-2 108, regarding DRMS data and copy control information which are directly accessible in the TS packet using the first CAS, CAS-1 104. DIS attributes meeting predetermined criteria can be executable programming instructions or data files. The predetermined criteria are used to determine sought after data in a TS packet. For instance, sought after data can be a static data set, such as a copy control information in a PAT of a TS packet which is associated with DM content in the TS packet payload. Predetermined criteria can also be used for seeking data to determine the change in a dynamic data set, such as a finding of a change in the DRMS data in the TS packet and associated with the DM content in the TS packet payload. At the time the processing module 102 analyzes the TS packet, the DRMS information and the copy control information are recognized in the processing module 102 as meeting the predetermined criteria for being sent to the CAS-2 108. The DRMS information and the copy control information are forwarded as DIS data 107 to the CAS-2 108. Other information in the TS packet may also be included as DIS data 107 according to other criteria. This information is then forwarded through the delivery network to the CAS-2 decryption subsystem for the CAS-2 108 forming decrypted data that is accessible by the device, such as an STB or an external headend facility operable with the CAS-2 108.

### 4. Method

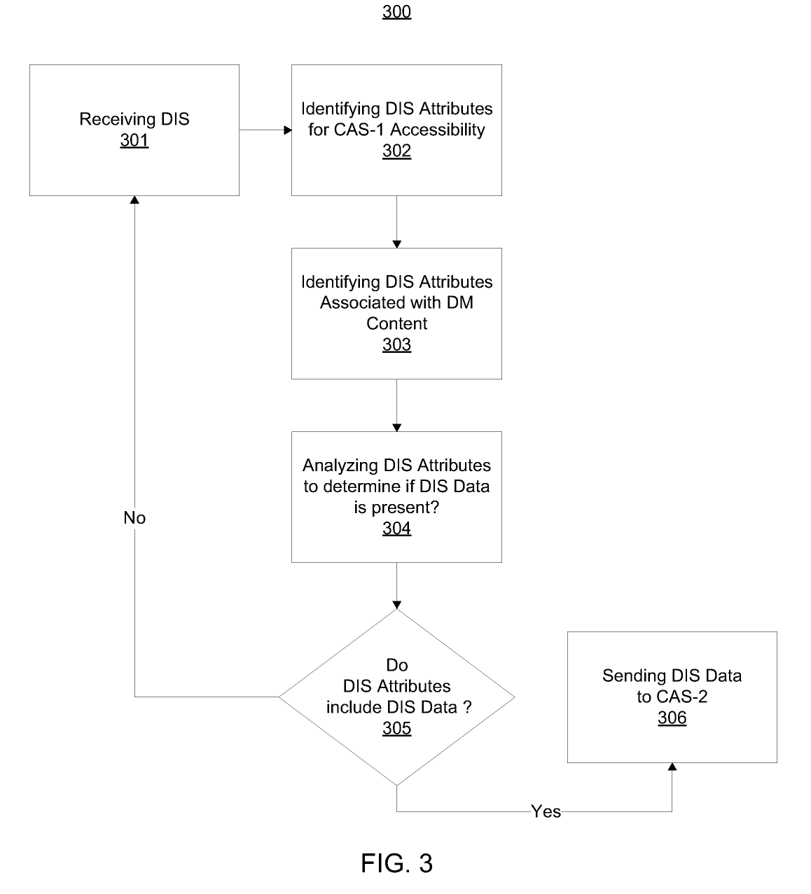

FIG. 3 illustrates a method 300, according to an embodiment, for communicating information from a DIS. The method herein is described with respect to the DISC system 100 shown in FIG. 1 by way of example and not limitation. This method may be performed in other systems. The steps of the methods may be performed in a different sequence or one or more may be omitted.

At step 301, the DIS 103 containing, for example, MPEG-2 TS packets, is received at the DISC system 100 which is incorporated into CAS-1 104 and may communicate with CAS-2 108 through a CAS network for messages relating to DIS data 107 in the MPEG-2 TS packets. The DISC system 100 receives the DIS 103 at the monitoring module 101.

At step 302, the monitoring module 101 identifies the DIS attributes in the MPEG-2 TS packets having DIS attributes for accessibility using the first CAS 104. This includes identifying the information in the MPEG-2 packets for which CAS-1 104 is authorized to access. These accessibility DIS attributes may relate to a DRMS associated with a DM content in the MPEG-2 packets. The DIS attributes for accessibility in the MPEG-2 packets which have been identified using the CAS-1 104 may be stored in a memory associated with the monitoring module 101, or otherwise associated with the DISC system 100. The monitoring module 101 forwards the MPEG-2 TS packets, and any other DIS attributes in DIS 103, to the processing module 102.

At step 303, the processing module 102 identifies the DIS attributes in the MPEG-2 TS packets associated with a digital media (DM) content in the DIS 103. For instance, the processing module 102 may identify information describing the size of the DM content data file or about the format of the DM content in the TS packet payload, such as formats for video, audio, text or some other format. The processing module 102 may identify other DIS attributes in DIS 103. These DIS attributes in the MPEG-2 packets which have been identified using the CAS-1 104 may be stored in a memory associated with the processing module 102, or otherwise associated with the DISC system 100.

At step 304, the processing module 102 analyzes all the DIS attributes which have been identified using the monitoring module 101 and/or the processing module 102. The analysis determines whether any of the DIS attributes meet any of the predetermined criteria for being the DIS data 107 which is to be sent to CAS-2 108. Predetermined criteria can be for locating DIS data 107 such as executable programming instructions or a data file. The predetermined criteria can be used to determine sought after DIS data 107 in a DIS packet. For instance, sought after data can be a static data set, such as copy control information in a PAT of a TS packet which is associated with DM content in the TS packet payload. Predetermined criteria can also be used for seeking DIS data 107 relating to a change in a dynamic data set, such as a finding of a change in the DRMS accessibility associated with the DM content in the TS packet payload.

At Step 305, if any of the identified DIS attributes include any of the DIS data 107, according to the predetermined criteria, these DIS attributes are tagged as DIS data 107. However, if none of the identified and analyzed DIS attributes meet any of the predetermined criteria, no further action is taken.

At step 306, the processing module 102 forwards any of the DIS data 107 meeting the predetermined criteria to an output subsystem and then to the CAS delivery network for delivering the DIS data 107 to CAS-2 108. For instance, if the DIS data 107 includes a copy control information field including the identity of the programmer of the DRMS associated with the DM content in a packet payload of the DIS 103, this information can be used in client devices operable with the CAS-2 108 for locating and contacting the programmer to obtain information regarding the DRMS system associated with the DM content.

### 5. Computer System for Executing Software

One or more of the steps and functions described herein and one or more of the components of the systems described herein may be implemented as computer code comprising computer readable instructions stored on a computer readable storage device, such as memory or another type of storage device. The computer code is executed on a computer system, such as computer system 300 described below by a processor, such as an application-specific integrated circuit (ASIC), or other type of circuit. The code may exist as software programs comprised of program instructions in source code, object code, executable code or other formats.

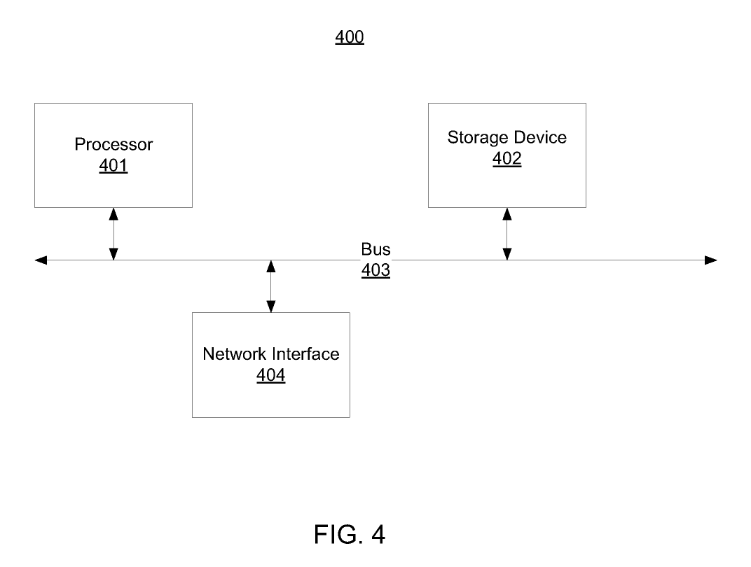

FIG. 4 shows a computer system 400 which may be used as a hardware platform for the DISC system 100. Computer system 400 may be used as a platform for executing one or more of the steps, methods, and functions described herein that may be embodied as software stored on one or more computer readable storage devices, which are hardware storage devices.

The computer system 400 includes a processor 401, or processing circuitry, that may implement or execute software instructions performing some or all of the methods, functions and other steps described herein. Commands and data from processor 401 are communicated over a communication bus 403. Computer system 400 also includes a computer readable storage device 402, such as random access memory (RAM), where the software and data for processor 401 may reside during runtime. Storage device 402 may also include non-volatile data storage. Computer system 400 may include a network interface 404 for connecting to a network. It is apparent to one of ordinary skill in the art that other known electronic components may be added or substituted in computer system 400.

Furthermore, the system and methods described herein are generally described with respect to monitoring digital information streams operable for digital program distribution purposes. However, the system and methods are applicable to monitoring digital information streams for other types of DM content.

While the embodiments have been described with reference to examples, those skilled in the art are able to make various modifications to the described embodiments without departing from the scope of the embodiments as described in the following claims, and their equivalents.

What is claimed is:

1. A digital information stream communication (DISC) system, within a first conditional access system (CAS), the DISC system configured to communicate information from a digital information stream (DIS) having DIS attributes for accessibility using the first CAS or associated with a digital media (DM) content in the DIS, the DISC system comprising:
a monitoring module configured to receive the DIS and identify one or more of the DIS attributes for accessibility using the first CAS;
a processing module configured to identify one or more of the DIS attributes associated with the DM content, analyze the DIS attributes to determine whether to send a DIS data from the DIS to a second CAS based upon the DIS data being included in the DIS attributes, and if the DIS data is not included in the DIS attributes, not send the DIS data to the second CAS; and
a processor configured to operate the monitoring module and the processing module.

2. The DISC system according to claim 1, wherein the processing module is configured to send the DIS data to the second CAS if the DIS data is included in the DIS attributes.

3. The DISC system according to claim 2, wherein the DIS data includes at least one of the DIS attributes for accessibility using the first CAS or associated with the DM content in the DIS.

4. The DISC system according to claim 1, wherein the first CAS accesses the DIS by utilizing a digital rights management system (DRMS) associated with the DM content.

5. The DISC system according to claim 1, wherein the second CAS is interactable with the first CAS through an encryption key-sharing interface.

6. The DISC system according to claim 3, wherein the DIS attributes for accessibility using the first CAS include information describing a change in the accessibility using the first CAS.

7. The DISC system according to claim 1, wherein the DIS data is publishable to an external headend system.

8. The DISC system according to claim 1, wherein the DIS data includes copy control information associated with the DM content.

9. A method of communicating information from a digital information stream (DIS) having DIS attributes for accessibility using a first CAS or associated with a digital media (DM) content in the DIS, the method comprising:
receiving the DIS at a first conditional access system (CAS);
identifying one or more of the DIS attributes for accessibility using the first CAS;
identifying one or more of the DIS attributes associated with the DM content;
analyzing, by a processor, the DIS attributes to determine whether to send a DIS data from the DIS to a second CAS based upon the DIS data being included in the DIS attributes, and if the DIS data is not included in the DIS attributes, not send the DIS data to the second CAS.

10. The method according to claim 9, the method further comprising sending the DIS data to the second CAS if the DIS data is included in the DIS attributes.

11. The method according to claim 9, wherein the DIS data includes at least one of the DIS attributes for accessibility using the first CAS or associated with the DM content in the DIS.

12. The method according to claim 9, wherein the first CAS accesses the DIS by utilizing a digital rights management system (DRMS) associated with the DM content.

13. The method according to claim 9, wherein the second CAS is interactable with the first CAS through an encryption key-sharing interface.

14. The method according to claim 11, wherein the DIS attributes for accessibility using the first CAS include information describing a change in the accessibility using the first CAS.

15. The method according to claim 9, wherein the DIS data is publishable to an external headend system.

16. The method according to claim 15, wherein the DIS data includes copy control information associated with DM content.

17. A non-transitory computer readable medium storing computer readable instructions that when executed by a computer system perform a method of communicating information from a digital information stream (DIS) having DIS attributes for accessibility using a first CAS or associated with a digital media (DM) content in the DIS, the method comprising:
receiving the DIS at a first conditional access system (CAS);
identifying one or more of the DIS attributes for accessibility using the first CAS;
identifying one or more of the DIS attributes associated with the DM content;
analyzing the DIS attributes to determine whether to send a DIS data from the DIS to a second CAS based upon the DIS data being included in the DIS attributes, and if the DIS data is not included in the DIS attributes, not send the DIS data to the second CAS.

18. The computer readable medium according to claim 17, the method further comprising sending the DIS data to the second CAS if the DIS data is included in the DIS attributes.

19. The computer readable medium according to claim 18, wherein the DIS data includes at least one of the DIS attributes for accessibility using the first CAS or associated with the DM content in the DIS.

20. The computer readable medium according to claim 19, wherein the first CAS accesses the DIS by utilizing a digital rights management system (DRMS) associated with the DM content.
